(19) United States
(12) Patent Application Publication
(10) Pub. No.: US 2013/0091862 A1
(43) Pub. Date: Apr. 18, 2013

(54) PRESSURIZED AUXILIARY POWER UNIT LUBRICATION SYSTEM

(71) Applicant: Omar I. Osorio, San Diego, CA (US)

(72) Inventor: Omar I. Osorio, San Diego, CA (US)

(21) Appl. No.: 13/273,286

(22) Filed: Oct. 14, 2011

(51) Int. Cl. F01M 1/00; F16H 57/04; F16N 7/00

(52) U.S. Cl. 60/785; 184/6; 184/6.12

(57) ABSTRACT

An exemplary lubrication system includes a flow path that carries fluid from a fluid supply through at least a portion of an auxiliary power unit to an outlet separate from the fluid supply. The fluid supply is pressurized to move the fluid along the flow path.

### BACKGROUND

This disclosure relates to a lubrication system associated with an auxiliary power unit (APU). The lubrication system provides fluid that cools and lubricates various components of the APU.

Some aircraft APUs include a generator driven by a turbomachine. The generator is typically mounted to a gearbox driven by the turbomachine. As known, the APU powers various systems of an aircraft, such as cooling and electrical systems, particularly when the aircraft is on the ground.

A lubrication system circulates a fluid, such as oil, along a flow path through at least the gearbox and the generator of the APU. The fluid removes thermal energy and lubricates these components. In many current systems, the fluid is then collected, cooled, cleaned, and reintroduced to the flow path. These current systems thus require an oil sump, an oil pump, and an oil filter. These components each add weight and complexity to the APU system.

### SUMMARY

An exemplary lubrication system includes a flow path that carries fluid from a fluid supply through at least a portion of an auxiliary power unit to an outlet separate from the fluid supply. The fluid supply is pressurized to move the fluid along the flow path.

An exemplary auxiliary power unit lubrication system includes a gearbox that rotatably couples a turbomachine to a generator. The system also includes a flow path that carries fluid from a fluid supply through at least one of the gearbox and the generator to an outlet where the fluid exits the flow path.

An exemplary method of lubricating an auxiliary power unit includes pressurizing a fluid supply to move fluid along a flow path that extends through at least a portion of an auxiliary power unit, and pressurizing the fluid supply to move fluid through an outlet of the flow path.

### DESCRIPTION OF THE FIGURES

The various features and advantages of the disclosed examples will become apparent to those skilled in the art from the detailed description. The FIGURE that accompanies the detailed description can be briefly described as follows:

FIG. 1 shows a highly schematic view of an example auxiliary power unit lubrication system.

### DETAILED DESCRIPTION

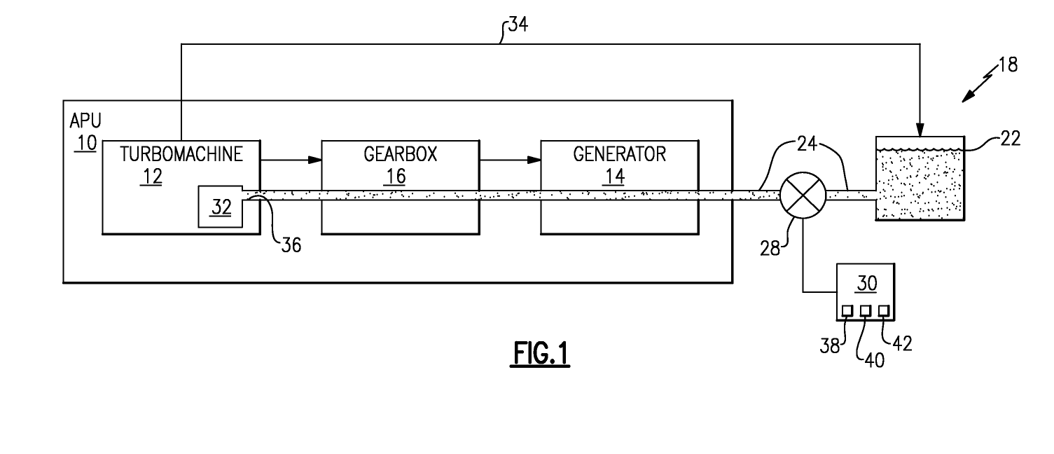

Referring to FIG. 1, an example auxiliary power unit (APU) 10 includes a turbomachine 12 rotatably coupled to a generator 14 through a gearbox 16. A lubrication system 18 lubricates and cools the APU 10.

In the example lubrication system 18, fluid from a pressurized fluid source 22 circulates along a flow path 24 through at least the gearbox 16 and the generator 14 of the APU 10. The fluid is an oil, for example, such as mill-prf-7808 or mill-prf-23699.

The fluid lubricates portions the APU 10, particularly bearings of the generator 14 and gearbox 16. The fluid also carries thermal energy to cool the generator 14 and the gearbox 16. It should be understood that the fluid system is exemplary and other circulation configurations may be used.

In this example, actuating a valve 28 within the flow path 24 regulates fluid flow along the flow path 24. The valve 28 moves from a closed position to an open position to permit more of the fluid to move along the flow path 24. The valve 28 moves from the open position to the closed position to permit less of the fluid to move along the flow path 24. The valve 28 is moveable to other positions between the open position and closed position.

In this example, a controller 30 controls actuations of the valve 28 to selectively move fluid along the flow path 24. The controller 30 allows more or less fluid to move along the flow path 24 in response to a rotational speed of the APU 10, a thermal energy level of the APU 10, etc. Notably, if too much fluid is provided to generator 14 or fluid is provided too soon during start up, then the generator 14 may undesirably drag and slow down the APU 10. The example controller 30 manipulates the position of the valve 28 to ensure that such surplus fluid is not provided.

Pressurizing the pressurized fluid source 22 forces the fluid to move along the flow path 24 when the valve 28 is in the open position. In this example, the pressurized fluid source 22, or bladder, is pressurized with bleed air from the turbomachine 12. Other examples pressurize the pressurized fluid source 22 using other techniques.

The bleed air, in this example, moves along a path 34 to the pressurized fluid source 22. Turbomachines 12 typically use bleed air to cool various turbomachine components as is known.

After the fluid has moved along the flow path 24 to remove thermal energy and lubricate, the fluid exits the flow path 24 at an outlet 36. In this example, the fluid moves from the outlet 36 into a combustor 32 of the turbomachine 12. The combustor 32 then combusts the fluid. The byproducts of combustion are expelled through an exhaust of the turbomachine 12. Other examples dispose of the fluid that has moved along the flow path 24 in other ways.

The flow path 24, in this example, thus extends from the pressurized fluid source 22 to the combustor 32 of the turbomachine 12. Notably, no fluid is recirculated back to the pressurized fluid source 22. The fluid moving along the flow path 24 is thus exclusively non-recirculated fluid.

It should be noted that the controller 30 is used to implement various functionality disclosed in this disclosure. In terms of hardware architecture, the controller 30 can include a processor 38, memory 40, and one or more input and/or output (I/O) device interface(s) 42 that are communicatively coupled via a local interface. The local interface can include, for example, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The processor 38 may be a hardware device for executing software, particularly software stored in memory 40. The processor 38 can be a custom made or commercially available processor, a central processing unit (CPU), an auxiliary processor among several processors associated with the controller, a semiconductor based microprocessor (in the form of a microchip or chip set) or generally any device for executing software instructions.

The memory 40 can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory 40 may incorporate electronic, magnetic, optical, and/or other types of storage media. Note that the memory 40 can also have a distributed architecture, where various components are situated remotely from one another, but can be accessed by the processor.

The software in the memory 40 may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

When the controller 30 is in operation, the processor 38 can be configured to execute software stored within the memory 40, to communicate data to and from the memory 40, and to generally control operations of the controller 30 pursuant to the software. Software in memory 40, in whole or in part, is read by the processor 38, perhaps buffered within the processor 38, and then executed.

Features of the disclosed examples include lubricating an APU 10 without the use of a separate sump, pump, and filter.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

I claim:

1. A lubrication system comprising:
a flow path that carries fluid from a fluid supply through at least a portion of an auxiliary power unit to an outlet separate from the fluid supply, wherein the fluid supply is pressurized to move the fluid along the flow path.

2. The lubrication system of claim 1, including a valve arranged in the flow path and configured to selectively permit fluid flow along the flow path in response to a command.

3. The lubrication system of claim 2, including a controller that actuates the valve to control flow of fluid from the pressurized fluid supply along the path.

4. The lubrication system of claim 1, wherein bleed air from a turbomachine pressurizes the pressurized fluid supply.

5. The lubrication system of claim 1, wherein the outlet delivers fluid to a combustor of a turbomachine.

6. The lubrication system of claim 1, wherein the flow path does not recirculate fluid in the flow path to the pressurized fluid supply.

7. An auxiliary power unit lubrication system, comprising:
a gearbox that rotatably couples a turbomachine to a generator; and
a flow path that carries fluid from a fluid supply through at least one of the gearbox and the generator to an outlet where the fluid exits the flow path.

8. The auxiliary power unit lubrication system of claim 7, wherein the fluid supply is pressurized using bleed air from the turbomachine to move the fluid along the flow path.

9. The auxiliary power unit lubrication system of claim 7, wherein the flow path carries exclusively non-recirculated fluid.

10. The auxiliary power unit lubrication system of claim 7, wherein no portion of the fluid carried by the flow path is recirculated fluid.

11. The auxiliary power unit lubrication system of claim 7, wherein bleed air from the turbomachine pressurizes the pressurized fluid supply.

12. A method of lubricating an auxiliary power unit, comprising:
pressurizing a fluid supply to move fluid along a flow path that extends through at least a portion of an auxiliary power unit; and
pressurizing the fluid supply to move fluid through an outlet of the flow path.

13. The method of claim 12, including selectively regulating the flow of fluid along the flow path using a valve.

14. The method of claim 12, including pressurizing using bleed air from a turbomachine of an auxiliary power unit.
